(19) United States
(12) Patent Application Publication
(10) Pub. No.: US 2013/0100180 A1
(43) Pub. Date: Apr. 25, 2013

(54) COLOR LCOS DISPLAY CHIP AND CONTROL METHOD

(71) Applicants: Yongping Dai, Shenzhen (CN); Xuhuai Dong, Shenzhen (CN); Wei Fan, Shenzhen (CN); Yi Fan, Shenzhen (CN)

(72) Inventors: Yongping Dai, Shenzhen (CN); Xuhuai Dong, Shenzhen (CN); Wei Fan, Shenzhen (CN); Yi Fan, Shenzhen (CN)

(73) Assignee: SHENZHEN YANGTZE LIVE CO. LTD

(21) Appl. No.: 13/320,544

(22) PCT Filed: Aug. 13, 2010
(86) PCT No.: PCT/CN10/75986

§ 371 Date: Nov. 15, 2011

(30) Foreign Application Priority Data
Jul. 13, 2010 (CN) 201010224999.X

(51) Int. Cl. G09G 3/36

(52) U.S. Cl. CPC G09G 3/36; G09G 2330/00
USPC 345/691; 345/88

(57) ABSTRACT

The present invention relates to a color LCOS display chip and the drive and control method thereof. With new structure design and drive and control method, the video signal nonlinear correcting chip, display drive signal control chip and other high cost special chips which are used in conventional control and drive circuit are abandoned. Multiple systems are integrated in a single chip to save PCB required for combination of multi-system chips, which leads to a lower production cost. The weight and size of control and drive circuit are reduced due to fewer integrated circuit chips and save of PCB. Power consumption is reduced without nonlinear correcting chips and display drive signal control chips. With the finite state machine (FSM) Scheduler as the core of digital signal processing module, the voltage coding value could be adjusted as per nonlinear characteristics of different crystal materials so as to achieve an optimal nonlinear correcting performance, which enhances the universality of the chip.

### FIELD OF THE INVENTION

The present invention relates to a display chip, particularly a color LCOS (Liquid Crystal On Silicon) display chip and the drive and control method thereof.

### BACKGROUND OF THE INVENTION

The demand for color LCOS display is increasing due to the rapid development of portable mobile communication and wireless display devices recently. The inherent advantage of LCOS display grants mobile display devices a bright future. In order to implement various and colorful functions, the current color LCOS display drive and control circuit adopts various IC (Integrated Circuit) chips, including image decoding chip, display drive signal control chip, MCU configuring chip, display drive power amplifying and operational amplifying module, multi-power module, and reactive sources electronic components, etc. The complicated circuit structure results in high cost, high power consumption and large size of the overall system. In addition, the nonlinear correcting chips for video signal and display drive signal control chips also contribute to the high power consumption.

### SUMMARY OF THE INVENTION

In order to reduce the cost, power consumption and size of overall system, the present invention provides a color LCOS display chip and the drive and control method thereof.

A color LCOS display chip, the said color LCOS display chip comprises: a 0V power rectifying circuit and a grounding pad connected to the said 0V power rectifying circuit, a RGB (Red-Green-Blue) input register and a RGB data input pad connected to the said RGB input register, a nonlinear correcting code searcher, a decoder, a multi-potential generator and a reference potential pad connected to the said multi-potential generator, a serial 2-wire circuit and a serial line pad connected to the said serial 2-wire circuit, a clock buffer and a RGB clock pad connected to the said clock buffer, a RGB synchronous clock generator, a row synchronous clock generator, a field synchronous clock generator, a charge pump, a 3.3V power rectifying circuit and a 3.3V power pad connected to the said 3.3V power rectifying circuit, a FSM scheduler and a RGB display executive circuit;

The said 0V power rectifying circuit is connected through 0V power line to the said RGB input register, the said nonlinear correcting code searcher, the said decoder, the said multi-potential generator, the said serial 2-wire circuit, the said clock buffer, the said RGB synchronous clock generator, the said row synchronous clock generator, the said field synchronous clock generator, the said charge pump, the said 3.3V power rectifying circuit, the said FSM scheduler and the said RGB display executive circuit. The 3.3V power rectifying circuit is connected through 3.3V power line to the said RGB input register, the said nonlinear correcting code searcher, the said decoder, the said multi-potential generator, the said serial 2-wire circuit, the said clock buffer, the said RGB synchronous clock generator, the said row synchronous clock generator, the said field synchronous clock generator, the said charge pump, the said FSM scheduler and the said RGB display executive circuit. The said charge pump is connected through 15V power line respectively to the said multi-potential generator and the said RGB display executive circuit. The said FSM scheduler outputs data to the said RGB input register through video input state control line, to the said nonlinear correcting code searcher through searcher state line, to the said decoder through decoder state line, outputs or reads data through serial state line from the said serial 2-wire circuit, receives data from the said RGB synchronous clock generator through RGB synchronization line, outputs data to the said row synchronous clock generator through row synchronization state control line, and outputs data to the said field synchronous clock generator through field synchronization state control line. The said RGB display executive circuit receives data from the said FSM scheduler through effective row drive line and effective column drive line respectively, receives data from the said row synchronous clock generator through row clock line, receives data from the said RGB synchronous clock generator through RGB synchronous clock line, receives data from the said nonlinear correcting code searcher through RGB correcting display data line, is connected to the said multi-potential generator through multi-potential reference power line, and receives data from the said field synchronous clock generator through field clock line. The said RGB input register outputs data to the said nonlinear correcting code searcher through RGB data line. The said decoder outputs data to the said multi-potential generator through decoder output line. The said clock buffer outputs data through clock line to the said RGB synchronous clock generator, to the said row synchronous clock generator and to the said field synchronous clock generator respectively.

The said RGB display executive circuit comprises: RGB display pixel array circuit, column RGB serial shifter register, column RGB bi-level parallel reset register, column RGB parallel reset level shifter, column RGB parallel reset DAC, serial row shifting register, parallel row reset level shifter and parallel row signal output driver;

The said column RGB serial shifting register, the said column RGB bi-level parallel reset register and the said serial row shifting register are connected to the said 0V power line and the said 3.3V power line respectively. The said RGB parallel reset level shifter, the said column RGB parallel reset DAC, the said parallel row reset level shifter and the said parallel row signal output driver are connected respectively to the said 0V power line and the said 15V power line. The said RGB display pixel array circuit is connected to the said 15V power line. The said column RGB serial shifting register receives data through row clock line and RGB synchronous clock line, and transmits data to the said column RGB bi-level parallel reset register through column serial shifting bus. The said column RGB bi-level parallel reset register receives data through RGB correcting display data line, and transmits data to the said RGB parallel reset level shifter through column register bus. The said RGB parallel reset level shifter transmits data to the said column RGB parallel reset DAC through column control bus. The said column RGB parallel reset DAC transmits data to the said RGB display pixel array circuit through RGB analog data output bus. The said column RGB parallel reset DAC is connected to multi-potential reference power line. The said serial row shifting register receives data through the said row clock line and the said field clock line, and transmits data to the said parallel row reset level shifter through serial shifting bus. The said parallel row reset level shifter transmits data to the said parallel row signal output driver through row register bus. The said parallel row signal output driver transmits data to the said RGB display pixel array circuit through digital addressing bus.

The said RGB display pixel array circuit comprises: no less than 2×2 RGB units with no less than 2 rows and no less than 2 columns, the said digital addressing bus consisting of no less than 2 parallel digital addressing lines, the said RGB analog data output bus consisting of no less than 2 groups with one R analog signal line, one G analog signal line and one B analog signal line in each group. The said RGB unit is connected to the said digital addressing line, the said R analog signal line, the said G analog signal line, the said B analog signal line and the said 15V power line respectively.

The said RGB unit comprises: red-light-reflected R pole, green-light-reflected G pole, blue-light-reflected B pole and 3 addressing unit circuits which are respectively connected to the said red-light-reflected R pole through R pole terminal, to the said green-light-reflected G pole through G pole terminal, to the said blue-light-reflected B pole through B pole terminal, and linked to the said R analog signal line, the said G analog signal line and the said B analog signal line respectively. The said addressing unit circuits are connected to the said 15V power line and the said digital addressing line respectively, and the said red-light-reflected R pole, the said green-light-reflected G pole and the said blue-light-reflected B pole are insulated from each other.

The said addressing unit circuit includes addressing PMOS tube comprises: addressing PMOS source, addressing PMOS grid, addressing PMOS drain and addressing PMOS back, and memory PMOS tube consisting of memory PMOS source, memory PMOS grid, memory PMOS drain and memory PMOS back. The said addressing PMOS grid is connected to the said digital addressing line. The said addressing PMOS back, the said memory PMOS source, the said memory PMOS drain and the said memory PMOS back are respectively connected to the said 15V power line. The said addressing PMOS source is connected to the analog signal input line. The said addressing PMOS drain and the said memory PMOS grid are respectively connected to pole output line.

When the said analog signal input line is connected to the said R analog signal line, the said pole output line is connected to the said R pole terminal. When the said analog signal input line is connected to the said G analog signal line, the said pole output line is connected to the said G pole terminal. When the said analog signal input line is connected to the said B analog signal line, the said pole output line is connected to the said B pole terminal.

A drive and control method applied to color LCOS display chip, which includes the steps as follows,

(1) The FSM scheduler is actuated after grounding pad connects to grounding line, 3.3V power pad connects to 3.3V power, and the reference potential pad connects to reference power.

(2) With the actuation of the said FSM scheduler, charge pump is started to supply 15V voltage to 15V power line; 0V power rectifying circuit is started to supply 0V voltage to 0V power line; 3.3V power rectifying circuit is started to supply 3.3V voltage to 3.3V power line; Clock buffer is started to output clock signal to clock line; Multi-potential generator is started to output reference potential to multi-potential reference power line; serial 2-wire circuit is started to receive data from serial line pad.

(3) Serial 2-wire circuit reads internal register configuration word initiated with addressing code from the said serial line pad.

(4) The said serial 2-wire circuit decides whether the addressing code is identical with the address code of chip. If true, step (5) will be executed; if false, step (3) will be repeated.

(5) Data from the said serial line pad is received, effective signal is written into the said FSM scheduler, and the circuit connected to the said FSM scheduler is started.

(6) The said FSM scheduler starts RGB input register to read RGB video data from RGB data input pad. Nonlinear correcting code searcher is started to transmit RGB correcting data to RGB correcting display data line. Decoder is started and voltage coding value is input to the said decoder. RGB synchronous clock generator is started to output RGB synchronous clock. Row synchronous clock generator is started to output row synchronous clock, while field synchronous clock generator is started to output field synchronous clock.

(7) Serial row shifting register is started to read the said row synchronous clock and the said field synchronous clock.

(8) Column RGB serial shifting register is started to read the said RGB synchronous clock and the said row synchronous clock.

(9) It is decided whether the falling edge of the said field synchronous clock is read when the said serial row shifting register is reading the high level of the said row synchronous clock. If true, pulse is output row by row starting from the first row of digital addressing line with the said row synchronous clock as cycle until the next effective synchronization. If false, step (7) is repeated and the said serial row shifting register continues reading the said field synchronous clock.

(10) It is decided whether the falling edge of the said row synchronous clock is read when the said column RGB serial shifting register is reading the high level of the said RGB synchronous clock. If true, analog signal is output column by column starting from the first column of RGB analog signal line with the said RGB synchronous clock as cycle until the next effective synchronization. If false, step (8) is repeated and the said column RGB serial shifting register reads the said row synchronous clock.

The technology provided by the present invention has the benefits as follows.

The color LCOS display chip and control and drive method thereof provided in the present invention, on the one hand, abandons high cost special chips such as video signal nonlinear correcting chip and display drive signal control chip used in the conventional control and drive circuit. On the other hand, production cost is extremely reduced because of multi-system integration in a single chip which saves PCB required for combination of multi-system chips. Weight and size of control and drive circuit is reduced because the quantity of IC chips is decreased and PCB is saved. Power consumption of the overall system is reduced because nonlinear correcting chips and display drive signal control chips are avoided. With the finite state machine (FSM) Scheduler as the core of digital signal processing module, the voltage coding value could be adjusted as per nonlinear characteristics of different crystal materials so as to achieve an optimal nonlinear correcting performance, which enhances the universality of the chip.

### BRIEF DESCRIPTION OF THE DRAWINGS

FIG. 1 is the structure diagram of the color LCOS display chip provided in the present invention;

FIG. 2 is the structure diagram of the RGB display executive circuit provided in the present invention;

FIG. 3 is the structure diagram of the RGB display pixel array circuit provided in the present invention;

FIG. 4 is the structure diagram of the RGB unit provided in the present invention;

FIG. 5 is the structure diagram of the addressing unit circuit provided in the present invention;

FIG. 6 is the flow chart of the drive and control method provided in the present invention.

The parts indicated by the numbers in the figures are as follows.

1: 0V power rectifying circuit; 2: RGB input register; 3: nonlinear correcting code searcher; 4: decoder; 5: multi-potential generator; 6: serial 2-wire circuit; 7: clock buffer; 8: RGB synchronous clock generator; 9: row synchronous clock generator; 10: field synchronous clock generator; 11: charge pump; 12: 3.3V power rectifying circuit; 13: FSM scheduler; 14: RGB display executive circuit; 15: grounding pad; 16: RGB data input pad; 17: reference potential pad; 18: serial line pad; 19: RGB clock pad; 20: 3.3V power pad; 21: video input state control line; 22: row clock line; 23: RGB synchronous clock line; 24: RGB correcting display data line; 25: data recorder state line; 26: decoder state line; 27: multi-potential reference power line; 28: serial state line; 29: clock line; 30: RGB synchronization line; 31: row synchronous state control line; 32: field synchronous state control line; 33: field clock line; 34: 15V power line; 35: 0V power line; 36: 3.3V power line; 37: effective column drive line; 38: effective row drive line; 39: RGB data line; 40: decoder output line; 51: RGB display pixel array circuit; 52: column RGB serial shifting register; 53: column RGB bi-level parallel reset register; 54: column RGB parallel reset level shifter; 55: column RGB parallel reset DAC; 56: serial row shifting register; 57: Parallel row reset level shifter; 58: parallel row signal output driver; 61: column serial shifting bus; 62: column register bus; 63: column control bus; 64: RGB analog data output bus; 65: row serial shifting bus; 66: row register bus; 67: addressing drive output bus; 71: digital addressing line; 72: RGB unit; 73: R analog signal line; 74: G analog signal line; 75: B analog signal line; 76: red-light-reflected R pole; 77: green-light-reflected G pole; 78: blue-light-reflected B pole; 79: R pole terminal; 80: G pole terminal; 81: B pole terminal; 82: addressing unit circuit; 83: Memory PMOS grid; 84: Memory PMOS drain; 85: Memory PMOS back; 86: Memory PMOS source; 91: Addressing PMOS tube; 92: Memory PMOS tube; 93: analog signal input line; 94: pole output line; 95: Addressing PMOS source; 96: addressing PMOS grid; 97: Addressing PMOS drain; 98: Addressing PMOS back.

### DETAILED DESCRIPTION OF PARTICULAR EMBODIMENTS OF THE INVENTION

In order to further clarify the aims, technical arts and advantages of the present invention, the embodiments of the present invention will be further explained with reference to the attached figures.

### Embodiment 1

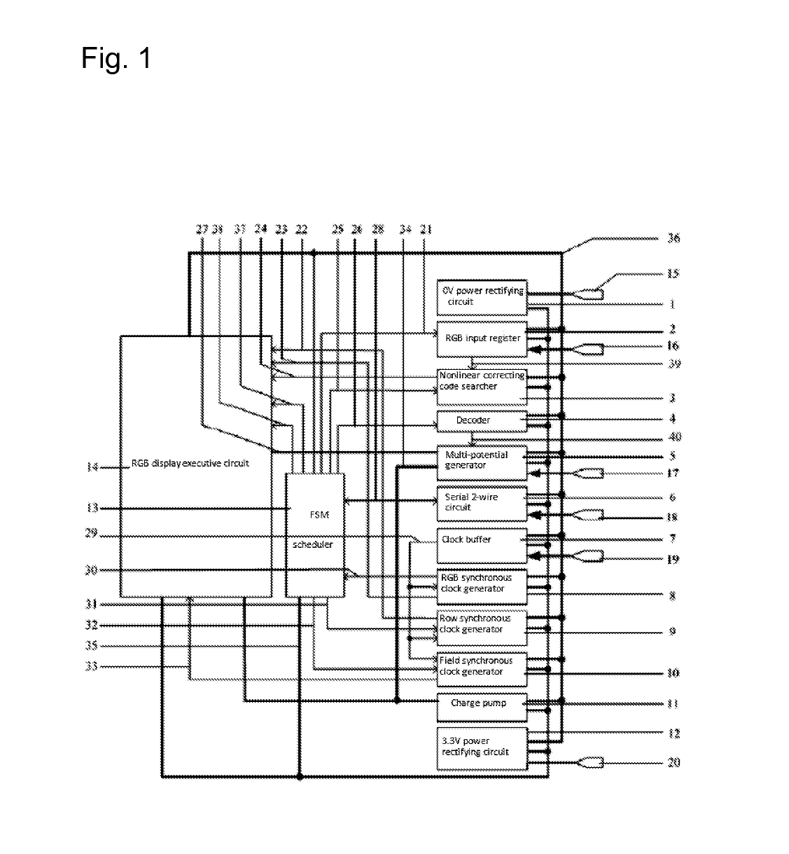

In order to reduce the cost, power consumption and size of the overall system, the present invention provides a color LCOS display chip, which is referred to in FIG. 1. The color LCOS display chip comprises: 0V power rectifying circuit 1 and grounding pad 15 which is connected to 0V rectifying power circuit 1, RGB input register 2 and RGB data input pad 16 which is connected to RGB input register 2, nonlinear correcting code searcher 3, decoder 4, multi-potential generator 5 and reference potential pad 17 which is connected to multi-potential generator 5, serial 2-wire circuit 6 and serial line pad 18 which is connected to serial 2-wire circuit 6, clock buffer 7 and RGB clock pad 19 which is connected to clock buffer 7, RGB synchronous clock generator 8, row synchronous clock generator 9, field synchronous clock generator 10, charge pump 11, 3.3V power rectifying circuit 12 and 3.3V power pad which is connected to 3.3V power rectifying circuit 12, FSM scheduler 13 and RGB display executive circuit 14.

The 0V power rectifying circuit 1 is connected through 0V power line 35 to the RGB input register 2, nonlinear correcting code searcher 3, decoder 4, multi-potential generator 5, serial 2-wire circuit 6, clock buffer 7, RGB synchronous clock generator 8, row synchronous clock generator 9, field synchronous clock generator 10, charge pump 11, 3.3V power rectifying circuit 12, FSM scheduler 13 and RGB display executive circuit 14. The 3.3V power rectifying circuit 12 is connected through 3.3V power line 36 to RGB input register 2, nonlinear correcting code searcher 3, decoder 4, multi-potential generator 5, serial 2-wire circuit 6, clock buffer 7, RGB synchronous clock generator 8, row synchronous clock generator 9, field synchronous clock generator 10, charge pump 11, FSM scheduler 13 and RGB display executive circuit 14. The charge pump 11 is connected through 15V power line 34 respectively to multi-potential generator 5 and RGB display executive circuit 14. The FSM scheduler 13 outputs data to RGB input register 2 through video input state control line 21, to nonlinear correcting code searcher 3 through searcher state line 25, to decoder 4 through decoder state line 26, outputs or receives data from serial 2-wire circuit 6 through serial state line 28, receives data from RGB synchronous clock generator 8 through RGB synchronization line 30, outputs data to row synchronous clock generator 9 through row synchronization state control line 31, and outputs data to field synchronous clock generator 10 through field synchronization state control line 32. The RGB display executive circuit 14 receives data from FSM scheduler 13 through effective row drive line 37 and effective column drive line 38 respectively, receives data from row synchronous clock generator 9 through row clock line 22, receives data from RGB synchronous clock generator 8 through RGB synchronous clock line 23, receives data from nonlinear correcting code searcher 3 through RGB correcting display data line 24, is connected to multi-potential generator 5 through multi-potential reference power line 27, and receives data from field synchronous clock generator 10 through field clock line 33. The RGB input register 2 outputs data to nonlinear correcting code searcher 3 through RGB data line 39. The decoder 4 outputs data to multi-potential generator 5 through decoder output line 40. The clock buffer 7 outputs data through clock line 29 to RGB synchronous clock generator 8, row synchronous clock generator 9 and field synchronous clock generator 10 respectively.

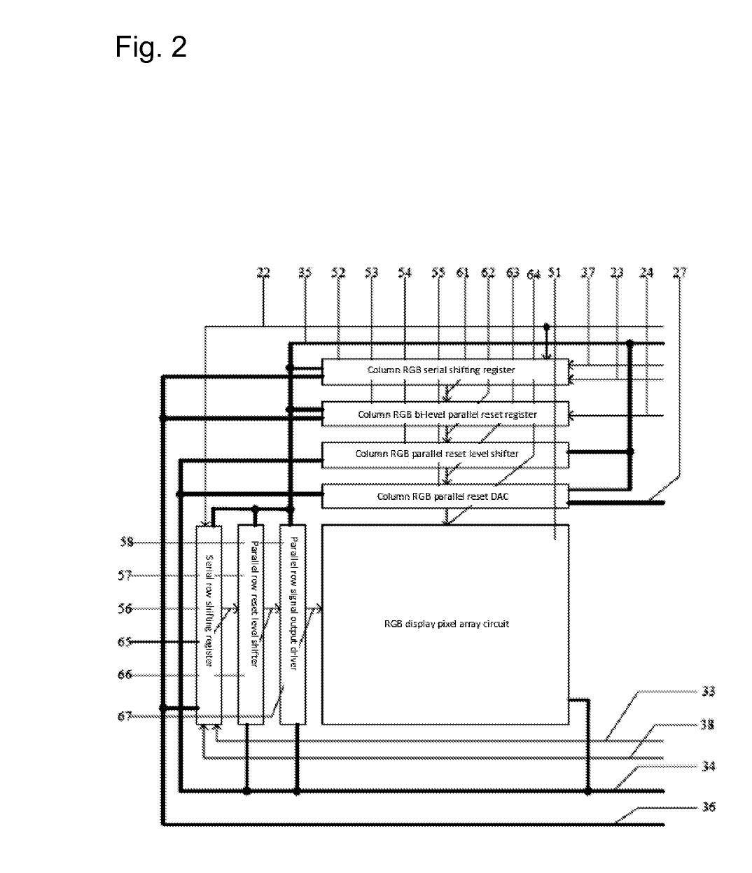

Refer to FIG. 2, furtherly, the RGB display executive circuit 14 comprises RGB display pixel array circuit 51, column RGB serial shifter register 52, column RGB bi-level parallel reset register 53, column RGB parallel reset level shifter 54, column RGB parallel reset DAC 55, serial row shifting register 56, parallel row reset level shifter 57 and parallel row signal output driver 58.

The column RGB serial shifting register 52, the column RGB bi-level parallel reset register 53 and serial row shifting register 56 are connected to 0V power line 35 and 3.3V power line 36 respectively. The RGB parallel reset level shifter 54, column RGB parallel reset DAC 55, parallel row reset level shifter 57 and parallel row signal output driver 58 are connected respectively to 0V power line 35 and 15V power line 34. RGB display pixel array circuit 51 is connected to 15V power line 34. The column RGB serial shifting register 52 receives data from row clock line 22, effective column drive line 37 and RGB synchronous clock line 23, and transmits data to column RGB bi-level parallel reset register 53 through column serial shifting bus 61. The column RGB bi-level parallel reset register 53 receives data through RGB correcting display data line 24, and transmits data to column RGB parallel reset level shifter 54 through column register bus 62. The column RGB parallel reset level shifter 54 transmits data to column RGB parallel reset DAC 55 through column control bus 63, while the column RGB parallel reset DAC 55 transmits data to RGB display pixel array circuit 51 through RGB analog data output bus 64. The column RGB parallel reset DAC 55 is connected to multi-potential reference power line 27. The serial row shifting register 56 receives data through row clock line 22, effective row drive line 38, and field clock line 33, and transmits data to parallel row reset level shifter 57 through serial shifting bus 65. The parallel row reset level shifter 57 transmits data to parallel row signal output driver 58 through row register bus 66. The parallel row signal output driver 58 transmits data to RGB display pixel array circuit 51 through digital addressing bus 67.

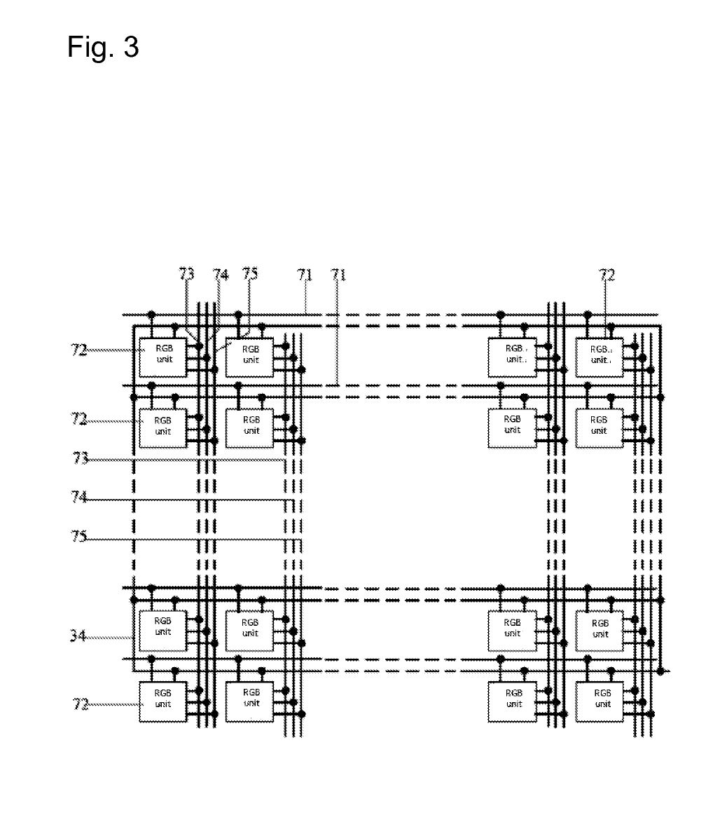

Refer to FIG. 3, furtherly, the RGB display pixel array circuit 51 comprises no less than 2×2 RGB units 72 with no less than 2 rows and no less than 2 columns, digital addressing bus 67 consisting of no less than 2 parallel digital addressing lines 71, the RGB analog data output bus 64 consisting of no less than 2 groups with one R analog signal line 73, one G analog signal line 74 and one B analog signal line 75 in each group. The digital addressing line 71 is isolated from R analog signal line 73, G analog signal line 74 and B analog signal line 75. The RGB unit 72 is connected to digital addressing line 71, R analog signal line 73, G analog signal line 74, B analog signal line 75 and 15V power line 34 respectively.

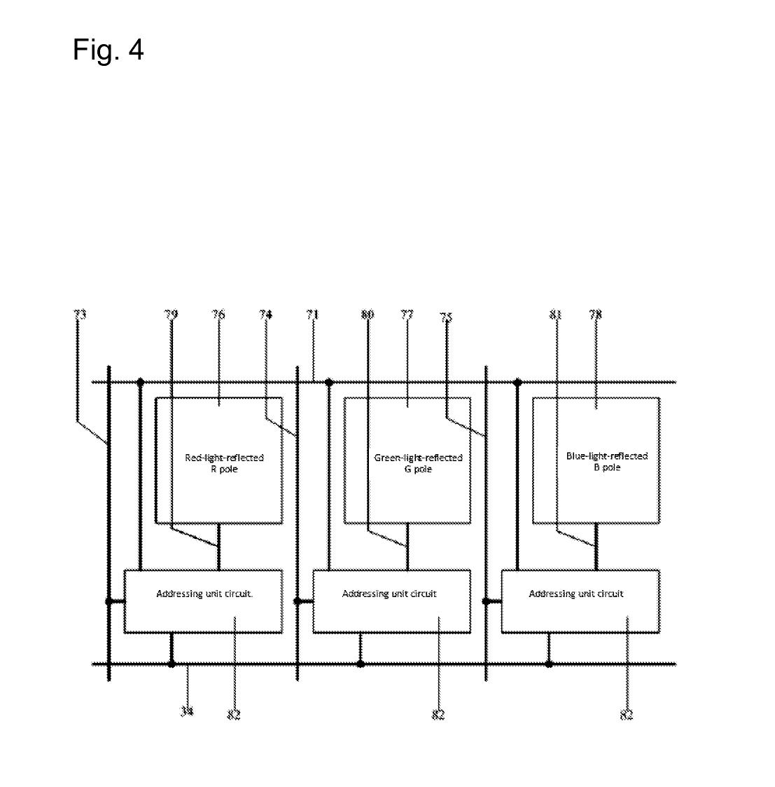

Refer to FIG. 4, furtherly, the RGB unit 72 comprises red-light-reflected R pole 76, green-light-reflected G pole 77, blue-light-reflected B pole 78 and 3 addressing unit circuits 82 which are respectively connected to red-light-reflected R pole 76 through R pole terminal 79, to green-light-reflected G pole 77 through G pole terminal 80, to blue-light-reflected B pole 78 through B pole terminal 81, and linked to R analog signal line 73, G analog signal line 74 and B analog signal line 75. The addressing unit circuits 82 are connected to 15V power line 34 and digital addressing line 71 respectively. The red-light-reflected R pole 76, the green-light-reflected G pole 77 and blue-light-reflected B pole 78 are insulated from each other.

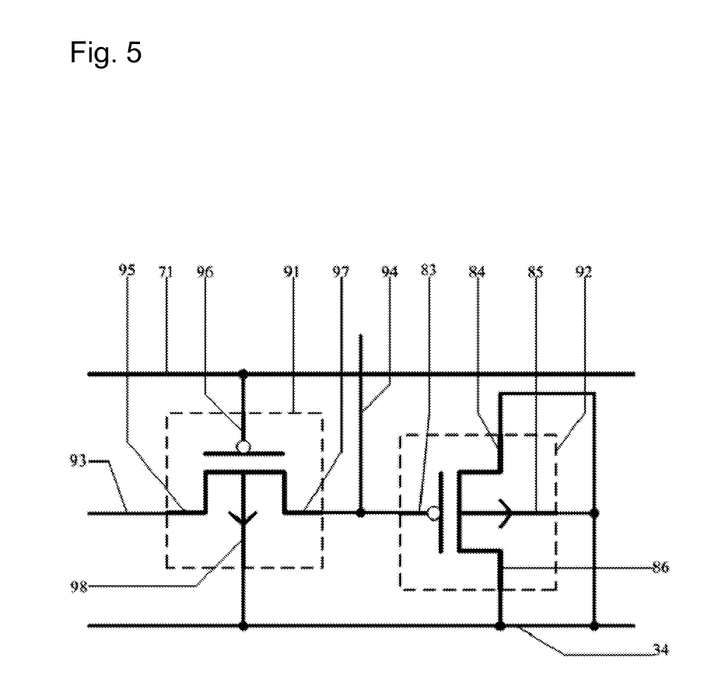

Refer to FIG. 5, furtherly, the addressing unit circuit 82 includes addressing PMOS tube 91 consisting of addressing PMOS source 95, addressing PMOS grid 96, addressing PMOS drain 97 and addressing PMOS back, and memory PMOS tube 92 consisting of memory PMOS source 86, memory PMOS grid 83, memory PMOS drain 84 and memory PMOS back 85. The addressing PMOS grid 96 is connected to digital addressing line 71. The addressing PMOS back 98, memory PMOS source 86, memory PMOS drain 84 and memory PMOS back 85 are respectively connected to 15V power line 34. The addressing PMOS source 95 is connected to analog signal input line 93. The addressing PMOS drain 97 and memory PMOS grid 83 are respectively connected to pole output line 94.

Furtherly, when analog signal input line 93 is connected to R analog signal line 73, pole output line 94 is connected to the R pole terminal 79. When analog signal input line 93 is connected to G analog signal line 74, pole output line 94 is connected to G pole terminal 80. When analog signal input line 93 is connected to B analog signal line 75, pole output line 94 is connected to B pole terminal 81.

As mentioned above, the present embodiment provides a color LCOS display chip. On the one hand, the design abandons high cost special chips such as video signal nonlinear correcting chip and display drive signal control chip used in the conventional control and drive circuit; on the other hand, production cost is extremely reduced because of multi-system integration in a single chip which saves PCB required for combination of multi-system chips. Weight and size of control and drive circuit is reduced because the quantity of IC chips is decreased and PCB is saved. The power consumption of the overall system is reduced because nonlinear correcting chips and display drive signal control chips are avoided. With the finite state machine (FSM) Scheduler as the core of digital signal processing module, the voltage coding value could be adjusted as per nonlinear characteristics of different crystal materials so as to achieve an optimal nonlinear correcting performance, which enhances the universality of the chip.

The details of how the color LCOS display chip works will be explained as follows with reference to FIG. 1, FIG. 2, FIG. 3, FIG. 4 and FIG. 5:

First, the FSM scheduler 13 is actuated after the color LCOS display chip is charged, which means that grounding pad 15 connects to grounding line, 3.3V power pad 20 connects to 3.3V power, and the reference potential pad 17 connects to reference power. With the actuation of FSM scheduler 13, charge pump 11 is started to supply 15V voltage to 15V power line 34; 0V power rectifying circuit 1 is started to supply 0V voltage to 0V power line 35; 3.3V power rectifying circuit 12 is started to supply 3.3V voltage to 3.3V power line 36; Clock buffer 7 is started to output clock signal to clock line 29; Multi-potential generator 5 is started to output reference potential to multi-potential reference power line 27; serial 2-wire circuit 6 is started to receive data from serial line pad 18 in compliance with I²C communication protocol. After being started, the serial 2-wire circuit 6 reads internal register configuration word initiated with addressing code from serial line pad 18. It is decided then whether the addressing code is identical with the address code of chip. If true, receiving data from serial line pad 18 is continued, effective signal is written back into FSM scheduler 13, to start the circuit connected to FSM scheduler 13. If false, internal register configuration word initiated with addressing code is read again from the serial line pad 18 until effective signal occurs. After reading effective signal from serial state line 28, the FSM scheduler 13 starts RGB input register 2 to read RGB video data from RGB data input pad 16, nonlinear correcting code searcher 3 is started to transmit RGB correcting data to RGB correcting display data line, decoder 4 is started and voltage coding value is input to decoder 4, and decoder 4 outputs decoder selected data to decoder output line 38. RGB synchronous clock generator 8 is started to output RGB synchronous clock. Row synchronous clock generator 9 is started to output row synchronous clock, while field synchronous clock generator 10 is started to output field synchronous clock. Serial row shifting register 56 is started to read row synchronous clock and field synchronous clock. RGB serial shifting register 52 is started to read RGB synchronous clock and row synchronous clock. After the serial row shifting register 56 reads row synchronous clock and field synchronous clock, it is decided whether the falling edge of field synchronous clock is read when serial row shifting register is reading the high level of row synchronous clock. If true, pulse is output row by row starting from the first row of digital addressing line with row synchronous clock as cycle until the next effective synchronization. If false, serial row shifting register 56 continues reading new field synchronous clock. After the RGB serial shifting register 52 reads RGB synchronous clock and row synchronous clock, it is decided whether the falling edge of row synchronous clock is read when RGB serial shifting register is reading the high level of RGB synchronous clock. If true, analog signal is output column by column starting from the first column of RGB analog signal line with RGB synchronous clock as cycle until the next effective synchronization. In a cycle of field synchronous clock, no less than 2 digital addressing lines sequentially receive an addressing pulse. The interval of the addressing pulses is equal to the cycle of row synchronous clock. In a cycle of row clock, no less than 2 groups of RGB analog signal line sequentially transmit a group of RGB analog signal. The interval between each group of RGB analog signal is equal to the cycle of RGB synchronous clock. When 0V potential is transmitted on digital addressing line, addressing PMOS grid 96 of the addressing PMOS tube 91 controls addressing PMOS source 95 to connect to addressing PMOS drain 97, the analog signal on analog signal line 93 is directly transmitted to and stored at memory PMOS grid 83 of the memory PMOS tube 92, and electric field effect is exerted to red-light-reflected R pole 76 (or green-light-reflected G pole 77, or blue-light-reflected B pole 78) through pole output line 94. When 15V potential is transmitted on digital addressing line, addressing PMOS grid 96 of addressing PMOS tube 91 controls addressing PMOS source 95 to disconnect from addressing PMOS drain, keep the charge stored in memory PMOS grid 83 of memory PMOS tube 92 unaffected, and electric field effect is exerted to red-light-reflected R pole 76 (or green-light-reflected G pole 77, or blue-light-reflected B pole 78) through pole output line 94.

### Embodiment 2

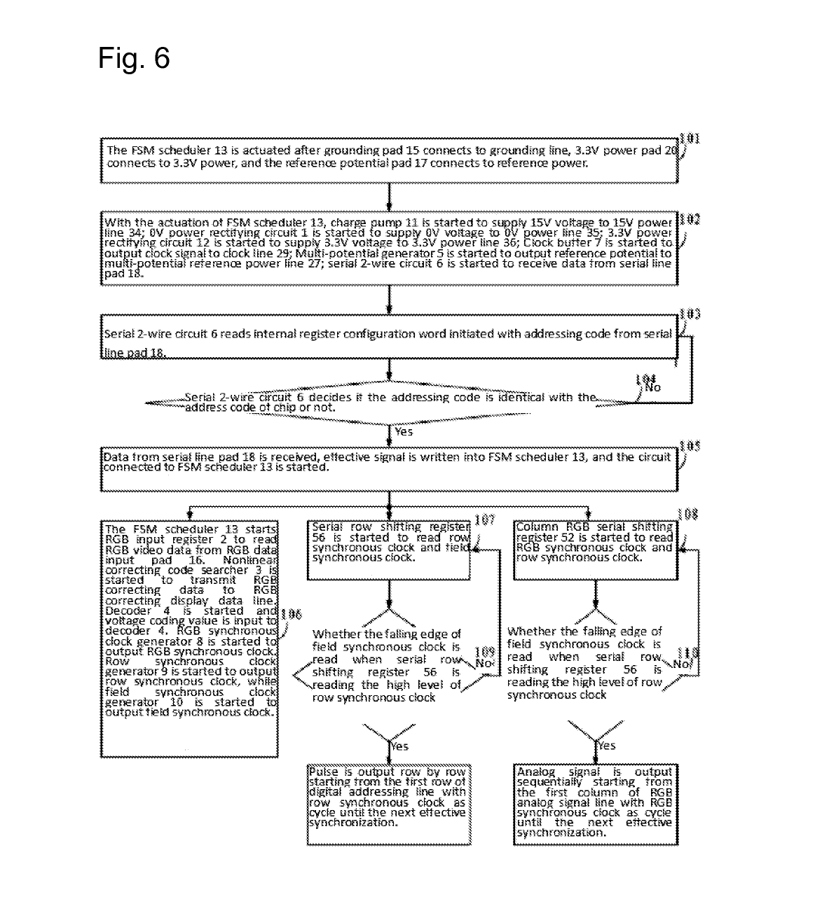

In order to reduce cost, power consumption and size of overall system, the present invention provides a control and drive method of a color LCOS display chip. Refer to FIG. 6, the method consists of the following steps:

101: The FSM scheduler 13 is actuated after grounding pad 15 connects to grounding line, 3.3V power pad 20 connects to 3.3V power, and the reference potential pad 17 connects to reference power;

102: With the actuation of FSM scheduler 13, charge pump 11 is started to supply 15V voltage to 15V power line 34; 0V power rectifying circuit 1 is started to supply 0V voltage to 0V power line 35; 3.3V power rectifying circuit 12 is started to supply 3.3V voltage to 3.3V power line 36; Clock buffer 7 is started to output clock signal to clock line 29; Multi-potential generator 5 is started to output reference potential to multi-potential reference power line 27; serial 2-wire circuit 6 is started to receive data from serial line pad 18;

The serial 2-wire circuit 6 complies with I²C communication protocol.

103: Serial 2-wire circuit 6 reads internal register configuration word initiated with addressing code from serial line pad 18;

104: Serial 2-wire circuit 6 decides whether the addressing code is identical with the address code of chip. If true, step (105) will be executed; if false, step (103) will be repeated;

105: Data from serial line pad 18 is received, effective signal is written into FSM scheduler 13, and the circuit connected to FSM scheduler 13 is started;

106: The FSM scheduler 13 starts RGB input register 2 to read RGB video data from RGB data input pad 16. Nonlinear correcting code searcher 3 is started to transmit RGB correcting data to RGB correcting display data line. Decoder 4 is started and voltage coding value is input to decoder 4. RGB synchronous clock generator 8 is started to output RGB synchronous clock. Row synchronous clock generator 9 is started to output row synchronous clock, while field synchronous clock generator 10 is started to output field synchronous clock;

The step that FSM scheduler 13 starts decoder 4 and inputs voltage coding value to decoder 4 in order to make decoder 4 output decoder selected data to decoder output line 40.

107: Serial row shifting register 56 is started to read row synchronous clock and field synchronous clock;

108: Column RGB serial shifting register 52 is started to read RGB synchronous clock and row synchronous clock;

Step 106, Step 107 and Step 108 are implemented simultaneously.

109: It is decided whether the falling edge of field synchronous clock is read when serial row shifting register 56 is reading the high level of row synchronous clock. If true, pulse is output row by row starting from the first row of digital addressing line with row synchronous clock as cycle until the next effective synchronization. If false, step (107) is repeated and serial row shifting register 56 continues reading field synchronous clock;

110: It is decided whether the falling edge of row synchronous clock is read when column RGB serial shifting register 52 is reading the high level of RGB synchronous clock. If true, analog signal is output sequentially starting from the first column of RGB analog signal line with RGB synchronous clock as cycle until the next effective synchronization. If false, step (108) is repeated and column RGB serial shifting register 52 reads row synchronous clock.

As mentioned above, the present embodiment provides a drive and control method applicable to color LCOS display chip. The cost, power consumption and size of the overall system are reduced by this method.

The foregoing descriptions are preferred embodiments of the present invention and are not used to limit the present invention. Any alteration, equivalent substitution, modification and improvement of the art without departing from the spirit and scope of the invention shall be included within the scope of the invention as claimed or the equivalents thereof.

What is claimed is:

1. A color LCOS display chip, characterized in that the said color LCOS display chip comprising: a 0V power rectifying circuit and a grounding pad connected to the said 0V power rectifying circuit, a RGB (Red-Green-Blue) input register and a RGB data input pad connected to the said RGB input register, a nonlinear correcting code searcher, a decoder, a multi-potential generator and a reference potential pad connected to the said multi-potential generator, a serial 2-wire circuit and a serial line pad connected to the said serial 2-wire circuit, a clock buffer and a RGB clock pad connected to the said clock buffer, a RGB synchronous clock generator, a row synchronous clock generator, a field synchronous clock generator, a charge pump, a 3.3V power rectifying circuit and a 3.3V power pad connected to the said 3.3V power rectifying circuit, a FSM scheduler and a RGB display executive circuit;
the said 0V power rectifying circuit is connected through 0V power line to the said RGB input register, the said nonlinear correcting code searcher, the said decoder, the said multi-potential generator, the said serial 2-wire circuit, the said clock buffer, the said RGB synchronous clock generator, the said row synchronous clock generator, the said field synchronous clock generator, the said charge pump, the said 3.3V power rectifying circuit, the said FSM scheduler and the said RGB display executive circuit; the 3.3V power rectifying circuit is connected through 3.3V power line to the said RGB input register, the said nonlinear correcting code searcher, the said decoder, the said multi-potential generator, the said serial 2-wire circuit, the said clock buffer, the said RGB synchronous clock generator, the said row synchronous clock generator, the said field synchronous clock generator, the said charge pump, the said FSM scheduler and the said RGB display executive circuit; the said charge pump is connected through 15V power line respectively to the said multi-potential generator and the said RGB display executive circuit; the said FSM scheduler outputs data to the said RGB input register through video a input state control line, to the said nonlinear correcting code searcher through a searcher state line, to the said decoder through a decoder state line, outputs or receives data from the said serial 2-wire circuit through serial state line, receives data from the said RGB synchronous clock generator through RGB synchronization line, outputs data to the said row synchronous clock generator through row synchronization state control line, and outputs data to the said field synchronous clock generator through field synchronization state control line; the said RGB display executive circuit receives data output by the said FSM scheduler through effective row drive line and effective column drive line respectively, receives data from the said row synchronous clock generator through row clock line, receives data from the said RGB synchronous clock generator through RGB synchronous clock line, receives data from the said nonlinear correcting code searcher through RGB correcting display data line, is connected to the said multi-potential generator through multi-potential reference power line, and receives data from the said field synchronous clock generator through field clock line; the said RGB input register outputs data to the said nonlinear correcting code searcher through RGB data line; the said decoder outputs data to the said multi-potential generator through decoder output line; the said clock buffer outputs data through clock line to the said RGB synchronous clock generator, the said row synchronous clock generator and the said field synchronous clock generator respectively.

2. A color LCOS display chip according to claim 1, characterized in that the said RGB display executive circuit consists of RGB display pixel array circuit, column RGB serial shifter register, column RGB bi-level parallel reset register, column RGB parallel reset level shifter, column RGB parallel reset DAC, serial row shifting register, parallel row reset level shifter and parallel row signal output driver;
the said column RGB serial shifting register, the said column RGB bi-level parallel reset register and the said serial row shifting register are connected to the said 0V power line and the said 3.3V power line respectively; the said RGB parallel reset level shifter, the said column RGB parallel reset DAC, the said parallel row reset level shifter and the said parallel row signal output driver are connected respectively to the said 0V power line and the said 15V power line; the said RGB display pixel array circuit is connected to the said 15V power line; the said column RGB serial shifting register receives data through row clock line, effective column drive line and RGB synchronous clock line, and transmits data to the said column RGB bi-level parallel reset register through column serial shifting bus; the said column RGB bi-level parallel reset register receives data through RGB correcting display data line, and transmits data to the said column RGB parallel reset level shifter through column register bus; the said column RGB parallel reset level shifter transmits data to the said column RGB parallel reset DAC through column control bus; the said column RGB parallel reset DAC transmits data to the said RGB display pixel array circuit through RGB analog data output bus; the said column RGB parallel reset DAC is connected to multi-potential reference power line; the said serial row shifting register receives data through the said row clock line, effective row drive line and the said field clock line, and transmits data to the said parallel row reset level shifter through serial shifting bus; the said parallel row reset level shifter transmits data to the said parallel row signal output driver through row register bus; the said parallel row signal output driver transmits data to the said RGB display pixel array circuit through digital addressing bus.

3. A color LCOS display chip according to claim 2, characterized in that the said RGB display pixel array circuit comprising: no less than 2×2 RGB units with no less than 2 rows and no less than 2 columns, the said digital addressing bus consisting of no less than 2 parallel digital addressing lines, the said RGB analog data output bus consisting of no less than 2 groups with one R analog signal line, one G analog signal line and one B analog signal line in each group; the said RGB unit is connected to the said digital addressing line, the said R analog signal line, the said G analog signal line, the said B analog signal line and the said 15V power line respectively.

4. A color LCOS display chip according to claim 3, characterized in that the RGB unit comprising a red-light-reflected R pole, a green-light-reflected G pole, a blue-light-reflected B pole and 3 addressing unit circuits which are respectively connected to the said red-light-reflected R pole through R pole terminal, to the said green-light-reflected G pole through G pole terminal, to the said blue-light-reflected B pole through B pole terminal, and linked to the said R analog signal line, the said G analog signal line and the said B analog signal line; the said addressing unit circuits are connected to the said 15V power line and the said digital addressing line respectively, and the said red-light-reflected R pole, the said green-light-reflected G pole and the said blue-light-reflected B pole are insulated from each other.

5. A color LCOS display chip according to claim 4, characterized in that the said addressing unit circuit includes addressing PMOS tube consisting of addressing PMOS source, addressing PMOS grid, addressing PMOS drain and addressing PMOS back, and memory PMOS tube consisting of memory PMOS source, memory PMOS grid, memory PMOS drain and memory PMOS back; the said addressing PMOS grid is connected to the said digital addressing line; the said addressing PMOS back, the said memory PMOS source, the said memory PMOS drain and the said memory PMOS back are respectively connected to the said 15V power line; the said addressing PMOS source is connected to the analog signal input line; the said addressing PMOS drain and the said memory PMOS grid are respectively connected to pole output line.

6. A color LCOS display chip according to claim 5, characterized in that when the said analog signal input line is connected to the said R analog signal line, the said pole output line is connected to the said R pole terminal; when the said analog signal input line is connected to the said G analog signal line, the said pole output line is connected to the said G pole terminal; when the said analog signal input line is connected to the said B analog signal line, the said pole output line is connected to the said B pole terminal.

7. A drive and control method applicable to the said color LCOS display chip according to claim 1, characterized in that the said method comprises the following steps:
(1) the FSM scheduler is actuated after grounding pad connects to grounding line, 3.3V power pad connects to 3.3V power, and the reference potential pad connects to reference power;
(2) with the actuation of FSM scheduler, charge pump is started to supply 15V voltage to 15V power line; 0V power rectifying circuit is started to supply 0V voltage to 0V power line; 3.3V power rectifying circuit is started to supply 3.3V voltage to 3.3V power line; Clock buffer is started to output clock signal to clock line; Multi-potential generator is started to output reference potential to multi-potential reference power line; serial 2-wire circuit is started to receive data from serial line pad;
(3) serial 2-wire circuit reads internal register configuration word initiated with addressing code from the said serial line pad;
(4) the said serial 2-wire circuit judges whether the addressing code is identical with the address code of chip. If true, step (5) will be executed; if false, step (3) will be repeated;
(5) receiving data from the said serial line pad, effective signal is written into the said FSM scheduler, and the circuit connected to the said FSM scheduler is started;
(6) the said FSM scheduler starting RGB input register to read RGB video data from RGB data input pad, the nonlinear correcting code searcher is started to transmit RGB correcting data to RGB correcting display data line, the decoder is started and voltage coding value is input to the said decoder, the RGB synchronous clock generator is started to output RGB synchronous clock, the row synchronous clock generator is started to output row synchronous clock, while field synchronous clock generator is started to output field synchronous clock;
(7) starting serial row shifting register to read the said row synchronous clock and the said field synchronous clock;
(8) Starting column RGB serial shifting register to read the said RGB synchronous clock and the said row synchronous clock;
(9) judging whether the falling edge of the said field synchronous clock is read when the said serial row shifting register is reading the high level of the said row synchronous clock; if true, pulse is output row by row starting from the first row of digital addressing line with the said row synchronous clock as cycle until the next effective synchronization; if false, step (7) is repeated and the said serial row shifting register continues to read the said field synchronous clock;
(10) judging whether the falling edge of the said row synchronous clock is read when the said column RGB serial shifting register is reading the high level of the said RGB synchronous clock; if true, analog signal is output column by column starting from the first column of RGB analog signal line with the said RGB synchronous clock as cycle until the next effective synchronization; if false, step (8) is repeated and the said column RGB serial shifting register reads the said row synchronous clock.
